(19) United States
(12) Patent Application Publication
(10) Pub. No.: US 2014/0319962 A1
(43) Pub. Date: Oct. 30, 2014

(54) ADJUSTABLE INSULATING COVER FOR A BAR-TO-BAR CONNECTION OF A STATOR WINDING IN A DYNAMOELECTRIC MACHINE

(71) Applicants: David Thomas Allen, Longwood, FL (US); Travis John Vitello, Oviedo, FL (US)

(72) Inventors: David Thomas Allen, Longwood, FL (US); Travis John Vitello, Oviedo, FL (US)

(21) Appl. No.: 13/873,525

(22) Filed: Apr. 30, 2013

(51) Int. Cl. H02K 3/38

(52) U.S. Cl. CPC H02K 3/38
USPC 310/260

(57) ABSTRACT

An insulated cover (10) for insulating at least two electrically-connected stator bar winding ends (18, 20) in a dynamoelectric machine. The cover (10) comprises a first member (12) for mating with a second member (14), a first interlocking structure (52) on a surface of the first member (12) and a second interlocking structure (50) on a surface of the second member (14). When the cover (10) is installed to insulate the bar winding ends (18, 20) by placing the first (12) and second (14) members in contact, the first (52) and second (50) interlocking structures positively lock to prevent relative displacement of the first (12) and second (14) members.

### FIELD OF THE INVENTION

The present invention relates generally to a device for forming a bar-to-bar connection of a stator winding, and more particularly to an insulating cover for forming the bar-to-bar connection.

### BACKGROUND OF THE INVENTION

An electric generator, one type of dynamoelectric machine, includes a cylindrical stator and a rotor disposed within a central opening of the stator. The rotor is mechanically rotated by a turbine. Rotor windings carry an electrical current that produces a magnetic field. Rotor rotation generates electric current in proximate stator windings as the rotor magnetic field cuts the stator windings. The stator current is supplied to a plurality of main and neutral electrical leads mounted to the generator frame then to electrical loads through a transmission and distribution system.

The stator core comprises thousands of thin steel laminations that may be stacked in a vertical orientation and clamped together to form a cylindrical stator core disposed within a generator frame. Each lamination defines a central opening and thus when stacked an axial opening extends through the core. The laminations may be held together by a plurality of axial through-bolts that extend from end-to-end through the core.

In most electric generators the stator windings comprise stator bars disposed in radial slots extending completely around the circumference of the stator core. Each stator bar further extends beyond an end face of the core. Certain of the bar ends comprise consolidated bar headers shaped to place two bar ends (a bar end pair) in close radial alignment beyond the core end face. Several of these bar end pairs are disposed around the circumference of the core. Within each bar end pair the two bar ends are electrically connected to form a bar end connection. The bar end connections are segregated into several alternating groups belonging to different winding phases. Each group comprises several bar end connections that when connected together form one phase winding.

A comparatively low voltage exists between any two adjacent bar end connections in one winding phase group. But the full voltage of the stator winding can be present between adjacent end connections of different phase groups. In modern generators, the stator winding voltage can reach a value of up to 30 kilovolts.

To avoid electrical breakdown between adjacent bar end connections, these end connections are insulated from each other. Furthermore, the insulating technique and materials must not deteriorate during operation, nor reduce the mechanical strength of the winding and in particular the end windings that can undergo high electrodynamical loads during the operation. The electrically insulating arrangement must remain intact during an extended period under various generator operating conditions, including high-voltage testing, high-load operation and transient short circuit currents.

The prior art discloses at least two electrically insulating arrangements for end connections of the stator winding bars. A continuous-tape arrangement comprises many turns of electrically insulating tape impregnated with insulating and bonding substances and thermally treated.

A barrier-arrangement comprises insulating members or barriers of various geometrical shapes installed between adjacent bar end connections to prevent the flow of breakdown current between these end connections.

### BRIEF DESCRIPTION OF THE DRAWINGS

The invention is explained in the following description in view of the drawings that show:

FIG. 1 is an illustration of an end view of a stator core depicting the stator bar ends and insulating cover for the stator bar ends.

FIG. 2 is a perspective view of the first and second members of the adjustable insulating cover of FIG. 1.

FIGS. 3 and 4 are close up views of one interlocking mechanism for use with the first and second members of FIG. 2.

FIG. 5 is an illustration of an end view of a stator core depicting the first and second members.

FIG. 6 is an exploded view of another embodiment of the adjustable insulating cover.

FIG. 7 is an illustration of yet another embodiment of the adjustable insulating cover.

FIG. 8 is an illustration of alignment structures for use with the first and second members of FIG. 2.

FIGS. 9 and 10 are illustrations of an insulated cover according to another embodiment of the invention.

### DETAILED DESCRIPTION OF THE INVENTION

The inventors have realized that use of the prior art tape arrangement complicates the generator assembly, disassembly and repair processes and does not provide an end winding construction with the desired mechanical stiffness. This method requires a series of assembly steps that may be difficult to perform and does not produce a consistent result based on field observations. A large number of individual pieces that do not positively lock together and must be temporarily clamped during curing of the resin-bonded pieces are also required. Also, the curing must be complete before proceeding to subsequent steps. The final step typically involves taping of the bar ends to provide a final redundant locking mechanism for securing the assembly in the event that the only existing locking mechanism (resin bonding) fails during operation of the generator. Clearly this method requires a significant time and many steps to execute.

The prior art barrier structures may be used in high voltage generators, but require additional parts that must be removed and then reinstalled during repair.

An embodiment of the present invention comprises an adjustable two-part insulating cover for a bar-to-bar end connection of a dynamoelectric machine, further comprising a positive locking component for removably joining the two parts. The cover reduces the number of individual parts required to assemble the cover thereby simplifying the overall complexity of assembly/reassembly and reducing assembly/reassembly time.

As shown in FIG. 1, in one embodiment a dielectric insulated cover 10 of the present invention comprises two interfacing members 12 and 14 surrounding end regions of two electrically connected stator bar winding ends 18 and 20. The bar winding ends 18 and 20 extend from a stator core end face 24. The cover 10 insulates the connected bar ends against flashover from proximate bar ends that also extend from the end face 24.

The cover 10 is attached to the bar winding ends by a chemical process, e.g., epoxy impregnated Dacron® cloth that is inserted between the bar winding ends and the cover 10 followed by resin coating of the cover 10.

Coolant channels 30 are also illustrated within each of the stator bar winding ends 18 and 20. A conductive plate 34 electrically connects two bar winding ends proximate an end region of each bar winding end.

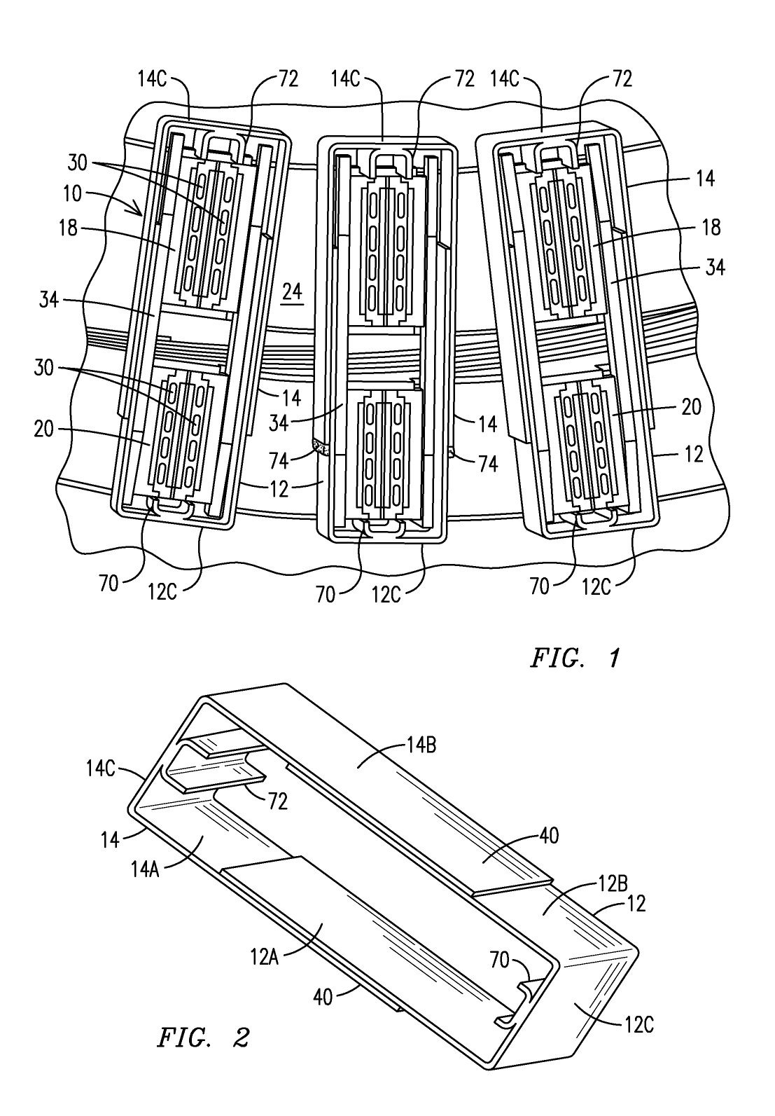

In the configuration of FIG. 1, the members 12 and 14 are configured to surround end regions of the bar winding ends 18 and 20 by radially displacing the member 12 toward an axial centerline of the end face 24 and/or radially displacing the member 14 in an opposite direction, i.e., away from the axial centerline of the end face 24. Thus as illustrated in FIGS. 1 and 2, when in place around end regions of the bar winding ends 18 and 20, the member 12 nests within the member 14 or is coupled to or mated with the member 14 according to various schemes and structures.

The members 12 and 14 are interlocked into removable engagement by an interlocking mechanism disposed in each overlap or interlock region 40. See FIG. 2.

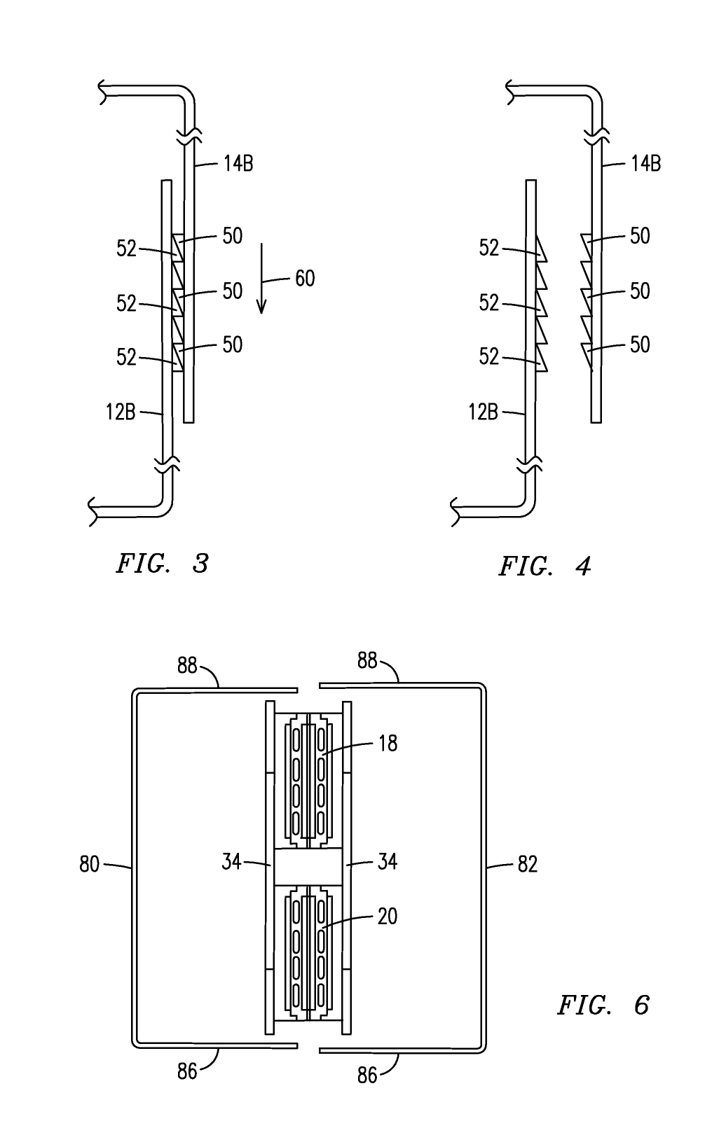

One embodiment of an interlocking mechanism is illustrated in a close up view of FIG. 3 in an engaged configuration and in the close-up view of FIG. 4 in a disengaged configuration. In this embodiment the interlocking mechanism comprises a plurality of tapered ridges (teeth) or protrusions 50 on an inwardly-facing surface of a leg or sidewall 14B that mate with corresponding tapered ridges (teeth) or protrusions 52 on an outwardly-facing surface of the leg or sidewall 12B.

The tapered ridges 50 and 52 may also be referred to as ratchets since they permit movement of the member 14 and its sidewall 14B toward a centerline of the stator relative to the member 12. This direction is illustrated by an arrowhead 60 in FIG. 3. But the shape and mating configuration of the ratchets prevent movement against the direction of the arrowhead 60. But note that the member 12 can be displaced radially inwardly toward the member 14 or the member 14 can be displaced radially outwardly toward the member 12. See also FIG. 5.

Use of the tapered ridges 50 and 52 additionally ensures that the cover 10 has been properly installed as a distinct “snap” will be heard as the ridges 50 and 52 engage. The “snap” sound indicates a positive locked condition, i.e., that the bar ends 18 and 20 have been captured within the dielectric insulated cover 10.

The ridges 50 and 52 described above may be disposed on one leg or sidewall of the members 12 and 14. In another embodiment a corresponding plurality of tapered ridges is also disposed on an inwardly-facing surface of a sidewall 14A of the member 14 for mating with a plurality of tapered ridges on an outwardly-facing surface of a sidewall 12A of the member 12. This additional plurality of ridges is not illustrated in the Figures.

Other geometrical shapes, referred to generally as engagement geometries, that provide a positive interlocking function for the members 12 and 14 can be used in lieu of the illustrated ridges. For example, a first of the members may be provided with an indentation in its surface or a complete through-wall opening formed therein, and the second of the members may be provided with a protrusion that slides along the wall of the first member as they are being drawn together during assembly, but then drops into the indentation or opening upon reaching an assembled position to lock the two members together.

Natural elasticity of the member walls may provide the force urging the protrusion into the indentation or opening, or the protrusion may be urged toward its assembled position by a spring or elastomeric material, for example a spring-loaded pin mechanism. In this embodiment the two members may be assembled into only a single geometry, or a selectable plurality of assembled geometries may be achieved by including more than one indentation/opening and/or more than one protrusion.

Other engagement geometries are known by those skilled in the art and therefore may be employed to provide the interlocking function. Certain of these engagement geometries may cooperate to permit relative movement of the members 12 and 14 together and toward an assembled condition, but prevent movement in an opposite direction.

It may be seen that the shapes interlock to permit displacement of one member relative to the other in a first direction but not in a second direction and that the shapes provide a positive locking mechanism.

To provide a long-term rigid joint between the members 12 and 14 a bonding material such as a varnish or epoxy resin is painted over overlapping side walls of the members 12 and 14 after the ratchet interlock has been achieved. The bonding agent material (see reference character 74 in FIG. 1) is applied and allowed to cure to provide additional structural support for retaining the members 12 and 14 in the desired positions.

Alternatively, the bonding material may be applied to the interlocking tapered ridges 50 and 52 prior to engagement of the members 12 and 14. After engagement, the bonding material cures to rigidly affix the tapered ridges 50 and 52 together.

FIG. 5 illustrates the members 12 in place around a lower portion of the bar winding ends 18 and 20 and the members 14 extending in a direction toward a centerline of the generator prior to locking with the member 12.

As further illustrated in FIGS. 1 and 2, in one embodiment ventilation channels 70 and 72 (also referred to as ventilation scoops) are affixed to or formed integrally with respective connecting segments 12C and 14C of the members 12 and 14. This embodiment with integral coolant channels reduces the number of components when compared with the bar end covers of the prior art.

A portion of core coolant exits the stator core through the ventilation channels 70 and 72 and is captured in a coolant plenum (not illustrated). Additional discharged core coolant exits the coolant channels 30.

In another embodiment the ventilation channels 70 and 72 are not formed integrally with the members 12 and 14, but the ventilation channels 70 and 72 are instead attached to any of the sidewalls 12A, 12B, 14A and 14B or the connecting segments 12C and 14C, as space permits, using a bonding agent (e.g., an epoxy resin bonding material), adhesive material, or another composite joining material known to those skilled in the art.

FIG. 7 illustrates another embodiment comprising members 90 and 92 in which the ventilation channels are not affixed to or formed integral with the members 90 and 92.

In an application employing the members 90 and 92, the ventilation channels 70 and 72 are installed after the members 90 and 92 are in place, thereby allowing custom installation of the ventilation channels 70 and 72. The ventilation channels 70 and 72 may be adjusted and located as necessary to accommodate the members 90 and 92 the bar winding ends 18 and 20 and the connecting plate 34. The ventilation channels 70 and 72 are fixed in position using a bonding agent (e.g., an epoxy resin bonding material), adhesive material, or another composite joining material known by those skilled in the art. Shims and/or Dacron® material may be used to properly locate the channels 70 and 72. Thus this embodiment allows custom installation and positioning of the ventilation channels 70 and 72.

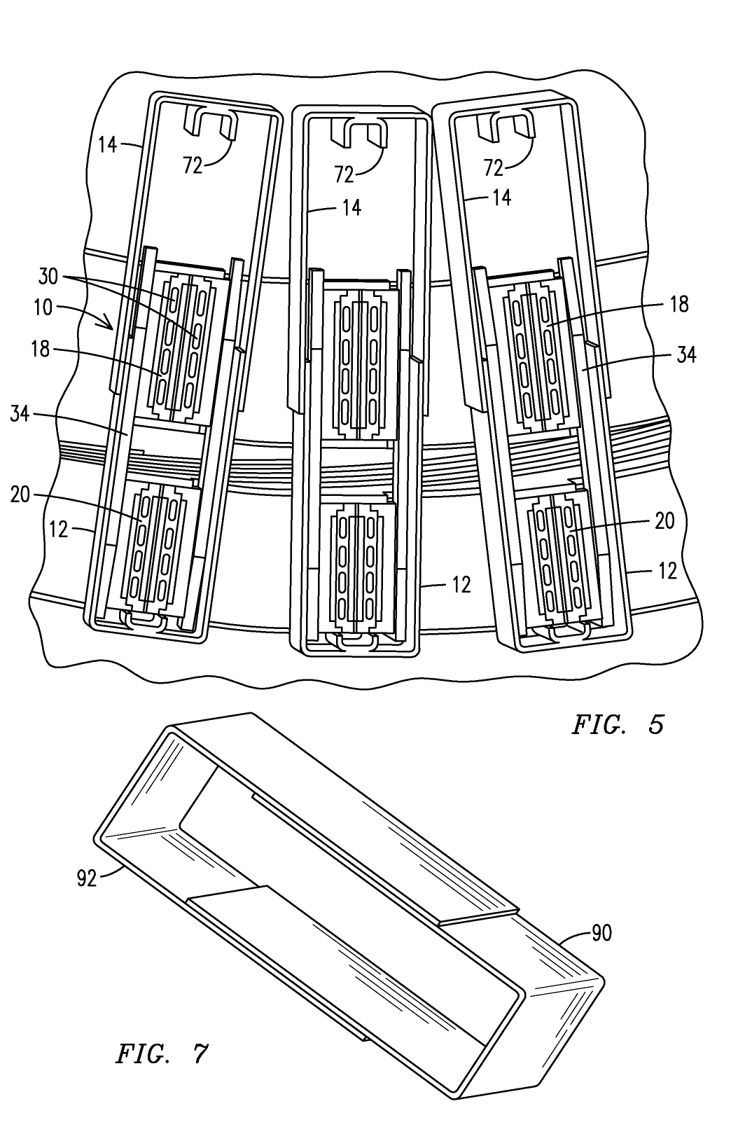

In another embodiment members 80 and 82 are displaced horizontally to engage around the bar ends 18 and 20. See the exploded view of FIG. 6. The members 80 and 82 comprise interlock or overlap regions 86 and 88 (proximate end surfaces of the bar ends 18 and 20) that further comprise an interlocking mechanism such as the tapered ridges described above.

The members 12, 14, 80 and 82 may be extruded with or without the ventilation channels 70 and 72. The molded extrusion material may comprise a composite of glass or mica dielectric insulating material in a resin based substrate. Alternatively, the members may be machined or cut from a block of insulating material, such as thermoset, which is typically a glass-fiber laminar weave in an epoxy substrate embedded with mica powder or an equivalent material. If the ventilation channels are absent, the members 12, 14, 80 and 82 may also be formed by spinning on a mandrel.

The described tapered regions 50 and 52 may be either part of the extruded cross-section of the members 12, 14, 80 and 82 or may be machined into these materials by removing material from appropriate surfaces of the members 12, 14, 80 and 82. In one embodiment, the ridges are between about 0.030 to about 0.045 inches in one direction and about 0.045 to about 0.068 inches in the other direction to form right-triangular sections as illustrated in FIGS. 3 and 4. A nominal wall thickness of the members 12 and 14 is between about 0.15 and about 0.18 inches.

In the embodiment of FIG. 2, the ventilation channels 70 and 72 may be machined from a green glass or equivalent composite block then bonded to each member 12, 14, 80 and 82 with an epoxy adhesive or another composite joining material.

Tangential or circumferential separation or misalignment of the insulated cover members 12 and 14 is typically caused by tangential separation or misalignment of the bar winding ends 18 and 20. This misalignment forms gaps between sidewalls 12A, 12B, 14A, and 14B and side surfaces of the two bar winding ends 18 and 20.

The gaps are closed by adding compensating support pads composed of resin or epoxy-impregnated Dacron®, a composite blocking material, or an equivalent gap-filling element familiar to those skilled in the art. The gaps may also be filled with an appropriate foam or plastic potting material.

The use of any of these gap-filling structures and adhesives tends to stiffen the insulated cover 10 surrounding the bar ends 18 and 20, which will improve dynamic response during operation of the generator. The forces exerted on inner surfaces of the members 12 and 14 by these structures and adhesives can also aid in mitigating the possibility of axial separation of the insulated cover members 12 and 14 during operation.

For the embodiment of FIG. 6 and its illustrated members 80 and 82, tangential or circumferential misalignment or separation is removed or at least minimized by displacement of the member 80 toward the member 82 or vice versa, after which the members 80 and 82 are locked into engagement. Gap filling materials are then used to eliminate any remaining circumferential gaps.

Returning to the embodiment of FIGS. 1 and 2 employing the members 12 and 14, radial offset or misalignment of the bar ends 18 and 20 is compensated or minimized by displacing the insulating cover members 12 and 14 along the interlocking tapered ridge 50 and 52, that is, by radial displacement of the member 12 toward the member 14 or vice versa.

One or both of the ventilation channels 70 and 72 may need to be repositioned or reduced in size if material removal is required to overcome interferences that may result due to such radial adjustments. The ventilation channels 70 and 72 may be oversized as necessary for the application or may be shimmed with blocks, Dacron® pads, or an equivalent structure if the channels are undersized (i.e. the channels do not fully occupy the radial gap between the ventilation channels 70 and 72 and the connecting segments 12C and 14C (see FIG. 2) of the respective members 12 and 14.)

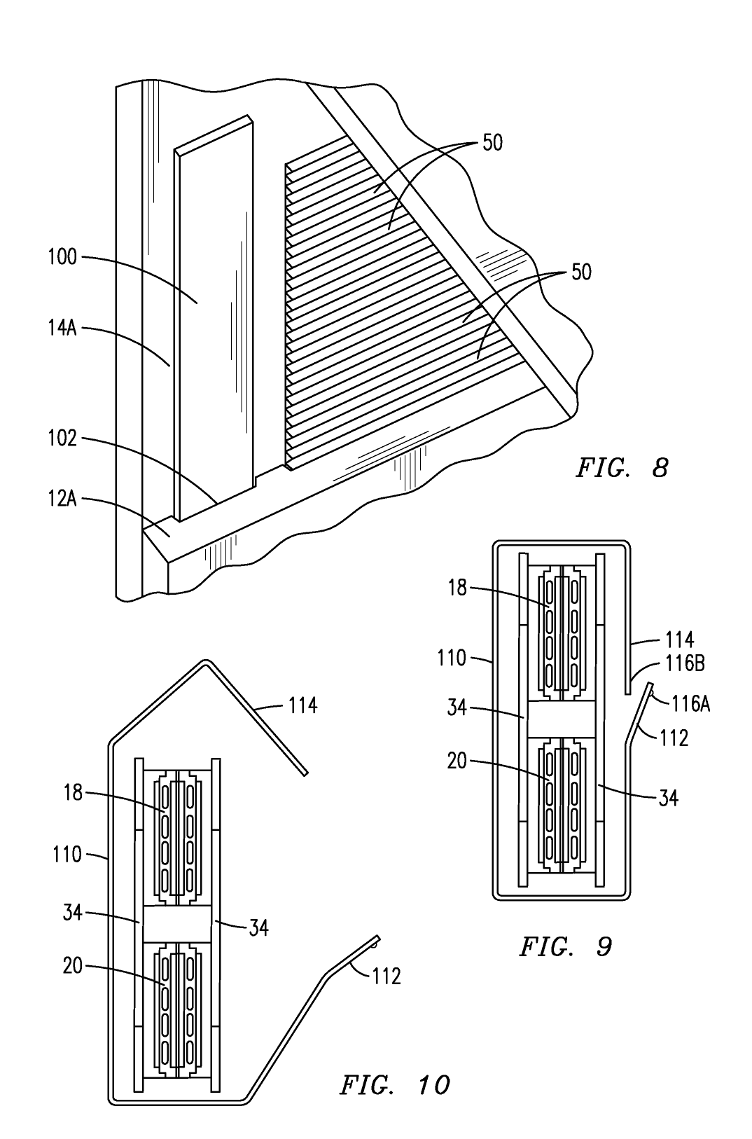

In one embodiment of the present invention a guide is provided to ensure quick and accurate alignment of the members 12 and 14. FIG. 8 illustrates this feature. One such guide structure comprises a tab 100 disposed on an inwardly-facing surface of the sidewall 14A of the member 14 for mating with a groove 102 disposed on an outwardly-facing surface of the sidewall 12A of the member 12.

The groove/tab pair may be disposed on one or both ends of the members 12 and 14.

FIG. 9 illustrates another embodiment of a cover for insulating a stator bar winding end 18 and/or 20 of a dynamoelectric machine wherein the members that are moved toward one another to install the cover are formed as end members of a deformable cover 110. The cover 110 is depicted in an installed condition in FIG. 9 and prior to installation in FIG. 10. As can be seen in FIG. 10 the cover 110 has been deformed into an open shape with the members 112, 114 apart to install the cover around the two bar winding ends 18 and 20. In FIG. 9 the cover 110 is closed by moving members 112, 114 together to enclose the cover 110 around the bar winding end. In one embodiment, the interlocking members 116A and 116B of the cover may comprise one or a plurality of protrusions 116A and one or a plurality of openings 1168.

The present invention is expected to reduce outage time during generator field service when removal and installation (and insulation) of the end windings is required. This invention reduces the number of unique assembly components compared to prior art techniques and reduces the number of unique assembly steps.

In addition to use in the field, the present invention reduces generator assembly time and provides a more consistent assembled product. This is facilitated in part due to the unique, snapping sound that will be heard as the members 12 and 14 are brought together during assembly.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A cover for insulating a stator bar winding end in a dynamoelectric machine, the cover comprising:
a first member for mating with a second member;
a surface of the first member comprising a first interlocking structure;
a surface of the second member comprising a second interlocking structure; and
when the cover is installed to insulate the bar winding end by placing the first and second members in contact, the first and second interlocking structures positively lock to prevent relative displacement of the first and second members.

2. The cover of claim 1 wherein the first member nests within the second member, the first interlocking structure comprises a plurality of ridges disposed on an outwardly-facing surface of the first member and the second interlocking structure comprises a plurality of ridges disposed on an inwardly-facing surface of the second structure, and when the cover is installed to insulate the bar winding end the first and second interlocking structures cooperate to permit relative displacement of the first and second members in a first direction and to prevent relative displacement in a second direction, wherein the first direction is opposite the second direction.

3. The cover of claim 2 wherein the first direction comprises displacement of one of the first and second members toward the other of the first and second members.

4. The cover of claim 2 further comprising a bonding agent adhering the first and second members together.

5. The cover of claim 1 wherein the first interlocking structure comprises an indentation or an opening and the second interlocking structure comprises a protrusion for capturing within the indentation or opening.

6. The cover of claim 1 further comprising at least one ventilation channel attached to one of the first and second members after the cover is installed to insulate the bar winding end.

7. The cover of claim 1 wherein the first and the second members each comprise first and second opposing side walls connected by a connecting segment, the first interlocking structure disposed on an outside-facing surface of a sidewall of the first member and the second interlocking structure disposed on inside-facing surface of a sidewall of the second member, wherein when the cover is installed to insulate the bar winding end, the first interlocking structure is interlocked with the second interlocking structure at an interlock region.

8. The cover of claim 7 wherein the interlock region is proximate a side surface of the bar winding end.

9. The cover of claim 8 wherein displacement of one of the first and second members toward the other of first and second members reduces radial gaps between the cover and the bar winding end.

10. The cover of claim 7 further comprising a first and a second ventilation channel each disposed on a respective connecting segment of the first and second members.

11. The cover of claim 7 wherein the interlock region is proximate an end surface of the bar winding end.

12. The cover of claim 11 wherein relative displacement of the members toward each other reduces circumferential gaps between the cover and the bar winding end.

13. The cover of claim 1 further comprising a gap-filling material disposed between an outwardly-facing surface of the bar winding end and an inwardly-facing surface of the cover.

14. The cover of claim 1 wherein the dynamoelectric machine comprises one of a generator and a motor.

15. The cover of claim 1 further comprising:
the first interlocking structure is disposed on a first outwardly-facing surface of the first member and the second interlocking structure is disposed on a first inwardly-facing surface of the second member;
the insulated cover further comprising a third interlocking structure disposed on a second outwardly-facing surface of the first member and a fourth interlocking structure disposed on a second inwardly-facing surface of the second member;
the first and second outwardly-facing surfaces spaced apart and the first and second inwardly-facing surfaces spaced apart;
and when the cover is installed to insulate the bar winding ends by placing the first and second members in contact, the first and second interlocking structures positively lock together and the third and fourth interlocking structures positively lock together.

16. A cover for insulating an electrically-connected stator bar winding end in a dynamoelectric machine, the cover comprising:
first and second end members, the cover deformable into a first shape with the members apart for installing the cover around the bar winding end, and deformable into a second shape with the members engaged together for closing the cover around the bar winding end; and
the first member comprising a first interlocking and the second member comprising a second interlocking structure cooperating with the first interlocking structure to positively lock the members together when the cover is closed around the bar winding end.

17. The cover of claim 16 wherein the cover comprises at least two rigid surfaces and a flexible material connecting the rigid surfaces.

18. A cover for a stator bar winding end in a dynamoelectric machine, the cover comprising:
first and second cover members configured to surround a stator bar winding end when assembled together in a dynamoelectric machine; and
an engagement geometry cooperating between the cover members and configured to permit relative movement of the cover members together and toward an assembled position and to prevent relative movement of the cover members apart and away from the assembled position.

19. The cover of claim 18 wherein the engagement geometry comprises first ridges on a surface of the first cover member mating with second ridges on a surface of the second cover member.
